(19) United States
(12) Patent Application Publication
(10) Pub. No.: US 2009/0209701 A1
(43) Pub. Date: Aug. 20, 2009

(54) WATER-BASED LACQUERS COMPRISING HIGHLY FUNCTIONAL, HIGHLY BRANCHED OR HYPERBRANCHED POLYCARBONATES

(75) Inventors: Bernhard Steinmetz, Rütschenhausen (DE); Bernd Bruchmann, Freinsheim (DE); Anke Küdde, Güntersleben (DE); Claudia Schneider, Arnstein-Müdesheim (DE); Udo Nenner, Wertheim (DE)

Correspondence Address: OBLON, SPIVAK, MCCLELLAND MAIER & NEUSTADT, P.C., 1940 DUKE STREET, ALEXANDRIA, VA, 22314, US

(73) Assignees: BASF SE,, LUDWIGSHAFEN (DE); BASF COATINGS AG,, MUENSTER (DE)

(21) Appl. No.: 12/307,840

(22) PCT Filed: Jun. 13, 2007
(86) PCT No.: PCT/EP07/55796

§ 371 Date: Jan. 7, 2009

(30) Foreign Application Priority Data
Jul. 20, 2006 (EP) 06117539.4

(51) Int. Cl. C09D 169/00

(52) U.S. Cl. 524/612

(57) ABSTRACT

The present invention relates to aqueous basecoat materials which comprise high-functionality, highly branched or hyperbranched polycarbonates based on dialkyl or diaryl carbonates or on phosgene, diphosgene or triphosgene and on aliphatic, aliphatic/aromatic or aromatic diols or polyols.

The present invention relates to aqueous basecoat materials which comprise high-functionality, highly branched or hyperbranched polycarbonates based on dialkyl or diaryl carbonates or on phosgene, diphosgene or triphosgene and on aliphatic, aliphatic/aromatic or aromatic diols or polyols.

EP 01124907 B1 describes polyethylene oxides and polypropylene oxides for improving the wetting of clearcoat material on basecoat material.

DE 19904330 A1 refers to the use of polypropylene glycol having a number-average molecular weight of approximately 900. Positive application properties are described in association with the use of this additive.

DE 3707388 A1 describes a polypropylene oxide with an average molar mass of 900 as a protective colloid for phyllosilicates, which finds use as a rheological additive in aqueous basecoat materials.

Polycarbonates are customarily obtained from the reaction of alcohols or phenols with phosgene or from the transesterification of alcohols or phenols with dialkyl or diaryl carbonates. Of industrial significance are aromatic polycarbonates, which are prepared, for example, from bisphenols; in terms of their market volume, aliphatic polycarbonates have to date played a minor role. On these points see also Becker/Braun, Kunststoff-Handbuch vol. 3/1, “Polycarbonate, Polyacetale, Polyester, Celluloseester”, Carl-Hanser-Verlag, Munich 1992, pages 118-119, and “Ullmann's Encyclopedia of Industrial Chemistry”, 6th Edition, 2000 Electronic Release, Verlag Wiley-VCH.

The aromatic or aliphatic polycarbonates described in the literature are generally linear or constructed with only a low degree of branching.

High-functionality polycarbonates of defined construction have only been known for a short time.

WO 2005/026234 describes the preparation of hyperbranched polycarbonates and also their use in coating materials in general, and also more particularly in printing inks.

Aqueous basecoat materials, however, are not mentioned.

International patent application WO 2006/089940 describes hyperbranched, highly branched or hyperbranched polycarbonates and also, in general, their use in powder coating materials.

Aqueous basecoat materials, however, are not described therein.

The unpublished European patent application with the file reference 06114213.9 and the filing date of May 19, 2006 describes powder coating materials with hyperbranched, highly branched or hyperbranched polcarbonates.

Aqueous basecoat materials, however, are not described therein.

S. P. Rannard and N. J. Davis, J. Am. Chem. Soc. 2000, 122, 11729, describe the preparation of perfectly branched dendrimeric polycarbonates by reacting carbonylbisimidazole as phosgene analog compound with bishydroxyethylamino-2-propanol.

Syntheses forming perfect dendrimers are multistage procedures which are therefore cost-intensive and hence unsuitable for transfer to the industrial scale.

D. H. Bolton and K. L. Wooley, Macromolecules 1997, 30, 1890, describe the preparation of highly rigid, high molecular weight, hyperbranched aromatic polycarbonates by reacting 1,1,1-tris(4′-hydroxyphenyl)ethane with carbonyl-bisimidazole.

Hyperbranched polycarbonates can also be prepared in accordance with WO 98/50453. According to the process described therein, triols are reacted again with carbonylbisimidazole. The initial products are imidazolides, which then undergo further, intermolecular reaction to form the polycarbonates. In accordance with the method stated the polycarbonates are obtained as colorless or pale yellow, rubberlike products.

Scheel and coworkers, Macromol. Symp. 2004, 120, 101, describe the preparation of polycarbonates based on triethanolamine and carbonylbisimidazole, but this preparation leads to thermally labile products.

The aforementioned syntheses giving highly branched or hyperbranched polycarbonates have the following disadvantages:
a) the hyperbranched products are high-melting, rubberlike or thermally labile, thereby significantly restricting the possibility for subsequent processing.
b) imidazole released during the reaction must be removed from the reaction mixture, which is costly and inconvenient to accomplish.
c) the reaction products always comprise terminal imidazolide groups. These groups are labile and must be converted into hydroxyl groups, for example, via a secondary step.
d) carbonyldiimidazole is a comparatively expensive chemical, which greatly increases the feedstock costs.

It was an object of the present invention to prepare aqueous basecoat materials having improved properties and/or improved optical qualities. A particular concern was to improve the wetting properties.

This object has been achieved by means of aqueous basecoat materials which comprise at least one high-functionality, highly branched or hyperbranched, uncrosslinked polycarbonate.

The present invention further provides for the use of high-functionality, highly branched or hyperbranched polycarbonates as an additive in aqueous basecoat materials. Forming one subject of the invention, therefore, is the use of high-functionality, highly branched or hyperbranched polycarbonates for reducing the wetting limit in the context of multicoat finishing, preferably two-coat finishing with aqueous basecoat material and clearcoat material.

In the context of the use, the high-functionality, highly branched or hyperbranched polycarbonates are added to the aqueous basecoat material prior to its application, preferably in a proportion of 0.1% to 15% by weight, based on its solid content.

Forming a further subject of the invention is an aqueous basecoat composition comprising one or more binders and, if appropriate, pigments and also, if appropriate, fillers, crosslinkers, organic solvents and/or typical coating additives, and further comprising one or more high-functionality, highly branched or hyperbranched polycarbonates in a proportion of 0.1% to 15% by weight, based on its solids content.

The high-functionality, highly branched or hyperbranched polycarbonates employed for this purpose are solid or liquid at room temperature (23° C.) and have in general a glass transition temperature of −70 to 50° C., preferably of −70 to 20° C., and more preferably of −50 to +10° C.

The glass transition temperature T_{g} is determined by the DSC (differential scanning calorimetry) method in accordance with ASTM 3418/82, with a heating rate of preferably 10° C./min.

The OH number to DIN 53240, part 2, of the hyperbranched polycarbonates is usually 100 mg KOH/g or more, preferably 150 mg KOH/g or more.

The viscosity to ISO 3219 of the polycarbonates in melt at 175° C. is between 0 and 20 000 mPas, preferably 0-15 000 mPas.

The weight-average molar weight M_{w} is usually between 1000 and 150 000, preferably from 2000 to 120 000 g/mol, and the number-average molar weight Mₙ between 500 and 50 000, preferably between 500 and 40 000 g/mol.

The polycarbonates exhibit an advantageous effect in the aqueous basecoat materials of the invention in particular as assistants for improving the wetting properties.

By hyperbranched polycarbonates are meant for the purposes of this invention uncrosslinked macromolecules containing hydroxyl and carbonate or carbamoyl chloride groups, which may be both structurally and molecularly nonuniform. On the one hand they may be synthesized starting from a central molecule in the same way as for dendrimers but with the chain length of the branches lacking uniformity. On the other hand they may also be of linear construction, with functional, branched side groups, or else, as a combination of the two extremes, may include linear and branched moieties. On the definition of dendrimeric and hyperbranched polymers see also P. J. Flory, J. Am. Chem. Soc. 1952, 74, 2718 and H. Frey et al., Chem. Eur. J. 2000, 6, No. 14, 2499.

By “highly branched” and “hyperbranched” in the context of the present invention is meant that the degree of branching (DB), i.e., the average number of dendritic linkages plus the average number of end groups per molecule, divided by the sum of the average number of dendritic linkages, the average number of linear linkages, and the average number of the end groups, multiplied by 100, is from 10% to 99.9%, preferably from 20% to 99%, more preferably 20%-95%.

By “dendrimeric” in the context of the present invention is meant that the degree of branching is 99.9%-100%. On the definition of “degree of branching” see H. Frey et al., Acta Polym. 1997, 48, 30.

It is an important feature of the polycarbonates that they are uncrosslinked. “Uncrosslinked” for the purposes of this specification means that the degree of crosslinking prevailing is less than 15% by weight, more preferably less than 10% by weight, determined via the insoluble fraction of the polymer.

The insoluble fraction of the polymer was determined by four-hour extraction in a Soxhlet apparatus with the same solvent as used for the gel permeation chromatography, i.e., selected from the group consisting of tetrahydrofuran, dimethylacetamide, and hexafluoroisopropanol, depending on which solvent has the better solvency for the polymer, by drying of the residue to constant weight and weighing of the residue remaining.

Preferably the process used to obtain the high-functionality, highly branched or hyperbranched, uncrosslinked polycarbonates comprises the steps of:
a) preparing one or more condensation products (K) by either
a1) reacting at least one organic carbonate (A) of general formula RO[(CO)O]ₙR with at least one aliphatic, aliphatic/aromatic or aromatic alcohol (B1) containing at least 3 OH groups, with elimination of alcohols ROH, R, independently at each occurrence, being a straight-chain or branched aliphatic, aromatic/aliphatic or aromatic hydrocarbon radical having 1 to 20 carbon atoms, and it also being possible for the radicals R to be joined to one another to form a ring, preferably a five- to six-membered ring, and n being an integer from 1 to 5
   or
a2) reacting phosgene, diphosgene or triphosgene with said aliphatic, aliphatic/aromatic or aromatic alcohol (B1), with release of hydrogen chloride,
   and
b) intermolecularly reacting the condensation products (K) to give a high-functionality, highly branched or hyperbranched polycarbonate,
   the proportion of the OH groups to the phosgenes or the carbonates in the reaction mixture being chosen such that the condensation products (K) contain on average either one carbonate or carbamoyl chloride group and more than one OH group, or one OH group and more than one carbonate or carbamoyl chloride group.

### Details of the Process now Follow.

The starting material used can be phosgene, diphosgene or triphosgene, preferably phosgene among these, although it is preferred to use organic carbonates (A).

The radicals R of the organic carbonate (A) starting materials of the general formula RO[(CO)O]ₙR are in each case independently of one another a straight-chain or branched aliphatic, aromatic/aliphatic (araliphatic) or aromatic hydrocarbon radical having 1 to 20 carbon atoms. The two radicals R may also be joined to one another to form a ring. The two radicals R may be identical or different; preferably they are identical. Each R is preferably an aliphatic hydrocarbon radical and more preferably a straight-chain or branched alkyl radical having 1 to 5 carbon atoms, or a substituted or unsubstituted phenyl radical.

R is a straight-chain or branched, preferably straight-chain, (cyclo)aliphatic, aromatic/aliphatic or aromatic, preferably (cyclo)aliphatic or aromatic, more preferably aliphatic hydrocarbon radical having 1 to 20 carbon atoms, preferably 1 to 12, more preferably 1 to 6, and very preferably 1 to 4 carbon atoms.

Examples thereof are methyl, ethyl, isopropyl, n-propyl, n-butyl, isobutyl, sec-butyl, tert-butyl, n-hexyl, n-heptyl, n-octyl, n-decyl, n-dodecyl, n-tetradecyl, n-hexadecyl, n-octadecyl, n-eicosyl, 2-ethylhexyl, cyclopentyl, cyclohexyl, cyclooctyl, cyclododecyl, phenyl, o- or p-tolyl or naphthyl. Preference is given to methyl, ethyl, n-butyl, and phenyl.

The radicals R can be identical or different; preferably they are identical.

The radicals R can also be joined to one another to form a ring. Examples of divalent radicals R of this kind are 1,2-ethylene, 1,2-propylene, and 1,3-propylene.

In general n is an integer from 1 to 5, preferably from 1 to 3, more preferably from 1 to 2.

The carbonates can preferably be simple carbonates of the general formula RO(CO)OR; in this case, in other words, n is 1.

Dialkyl or diaryl carbonates can be prepared for example from the reaction of aliphatic, araliphatic or aromatic alcohols, preferably monoalcohols, with phosgene. Additionally they can also be prepared by oxidative carbonylation of the alcohols or phenols by means of CO in the presence of noble metals, oxygen or NOₓ. On preparation methods of diaryl or dialkyl carbonates see also “Ullmann's Encyclopedia of Industrial Chemistry”, 6th Edition, 2000 Electronic Release, Wiley-VCH.

For the invention no significant part is played by the manner in which the carbonate has been prepared.

Examples of suitable carbonates comprise aliphatic, aromatic/aliphatic or aromatic carbonates such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, di-n-propyl carbonate, di-n-butyl carbonate, diisobutyl carbonate, dipentyl carbonate, dihexyl carbonate, dicyclohexyl carbonate, diheptyl carbonate, dioctyl carbonate, didecyl carbonate or didodecyl carbonate.

Examples of carbonates where n is greater than 1 comprise dialkyl dicarbonates, such as di(tert-butyl) dicarbonate, or dialkyl tricarbonates such as di(tert-butyl) tricarbonate.

Preference is given to using aliphatic carbonates, especially those where the radicals comprise 1 to 5 carbon atoms, such as, for example, dimethyl carbonate, diethyl carbonate, di-n-propyl carbonate, di-n-butyl carbonate or diisobutyl carbonate. One preferred aromatic carbonate is diphenyl carbonate.

The organic carbonates are reacted with at least one aliphatic or aromatic alcohol (B1) which contains at least 3 OH groups, or with mixtures of two or more different alcohols.

The alcohol (B1) can be branched or unbranched, substituted or unsubstituted, and have 3 to 26 carbon atoms. It is preferably a (cyclo)aliphatic, more preferably an aliphatic, alcohol.

Examples of compounds having at least three OH groups comprise glycerol, trimethylolmethane, trimethylolethane, trimethylolpropane, trimethylolbutane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylol-propane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, sugars, such as glucose, for example, sugar derivatives, such as sorbitol, mannitol, diglycerol, threitol, erythritol, adonitol (ribitol), arabitol (Iyxitol), xylitol, dulcitol (galactitol), maltitol, isomalt, polyetherols having a functionality of three or more and based on alcohols with a functionality of three or more and ethylene oxide, propylene oxide or butylene oxide or mixtures thereof, or polyesterols.

Said alcohols containing at least three OH groups may if appropriate also be alkoxylated: that is, they may have been reacted with one to 30, preferably one to 20, more preferably one to 10, and very preferably one to five molecules of ethylene oxide and/or propylene oxide and/or isobutylene oxide per hydroxyl group.

In this context, glycerol, trimethylolethane, trimethylolpropane, 1,2,4-butanetriol, pentaerythritol, and polyetherols thereof based on ethylene oxide and/or propylene oxide are particularly preferred.

These polyfunctional alcohols can also be used in a mixture with difunctional alcohols (B2), with the proviso that the average OH functionality of all alcohols employed is together more than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, 1,2- or 1,3-cyclopentanediol, 1,2-, 1,3- or 1,4-cyclohexanediol, 1,1-, 1,2-, 1,3- or 1,4-cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxybiphenyl, bis(4-hydroxyphenyl) sulfide, bis(4-hydroxy-phenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxy-phenyl)propane, 1,1-bis(p-hydroxyphenyl)cyclohexane, dihydroxybenzophenone, difunctional polyetherpolyols based on ethylene oxide, propylene oxide, butylene oxide or mixtures thereof, polytetrahydrofuran having a molar weight of 162 to 2000, polycaprolactone or polyesterols based on diols and dicarboxylic acids.

The diols serve to fine-tune the properties of the polycarbonate. If difunctional alcohols are used, the ratio of difunctional alcohols (B2) to the at least trifunctional alcohols (B1) is laid down by the skilled worker in accordance with the desired properties of the polycarbonate. As a general rule the amount of the alcohol or alcohols (B2) is 0 to 39.9 mol % based on the total amount of all alcohols (B1) and (B2) together. Preferably the amount is 0 to 35 mol %, more preferably 0 to 25 mol %, and very preferably 0 to 10 mol %.

The alcohols (B1) and (B2) are here designated together as (B).

The reaction of phosgene, diphosgene or triphosgene with the alcohol or alcohol mixture takes place in general with elimination of hydrogen chloride; the reaction of the carbonates with the alcohol or alcohol mixture to give the high-functionality highly branched polycarbonate takes place with elimination of the monofunctional alcohol or phenol from the carbonate molecule.

The high-functionality highly branched polycarbonates formed by the process described are terminated after the reaction, i.e., without further modification, with hydroxyl groups and with carbonate groups or carbamoyl chloride groups. They dissolve readily in a variety of solvents.

Examples of such solvents are aromatic and/or (cyclo)aliphatic hydrocarbons and mixtures thereof, halogenated hydrocarbons, ketones, esters and ethers.

Preference is given to aromatic hydrocarbons, (cyclo)aliphatic hydrocarbons, alkyl alkanoates, ketones, alkoxylated alkyl alkanoates, and mixtures thereof.

Particular preference is given to mono- or polyalkylated benzenes and naphthalenes, ketones, alkyl alkanoates, and alkoxylated alkyl alkanoates, and also mixtures thereof.

Preferred aromatic hydrocarbon mixtures are those which comprise predominantly aromatic C₇ to C₁₄ hydrocarbons and can comprise a boiling range of 110 to 300° C., more preferably toluene, o-, m- or p-xylene, trimethylbenzene isomers, tetramethylbenzene isomers, ethylbenzene, cumene, tetrahydronaphthalene, and mixtures comprising them.

Examples thereof are the Solvesso® grades from ExxonMobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® grades from Shell. Hydrocarbon mixtures made up of paraffins, cycloparaffins, and aromatics are also available commercially under the designations Kristalloel (for example, Kristalloel 30, boiling range about 158-198° C., or Kristalloel 60: CAS No. 64742-82-1), white spirit (likewise, for example, CAS No. 64742-82-1) or solvent naphtha (light: boiling range about 155-180° C.; heavy: boiling range about 225-300° C.). The aromatics content of hydrocarbon mixtures of this kind is generally more than 90% by weight, preferably more than 95%, more preferably more than 98%, and very preferably more than 99% by weight. It can be sensible to use hydrocarbon mixtures having a particularly reduced naphthalene content.

The amount of aliphatic hydrocarbons is generally less than 5%, preferably less than 2.5%, and more preferably less than 1% by weight.

Halogenated hydrocarbons are, for example, chlorobenzene and dichlorobenzene or its isomer mixtures.

Esters are, for example, n-butyl acetate, ethyl acetate, 1-methoxyprop-2-yl acetate, and 2-methoxyethyl acetate.

Ethers are, for example, THF, dioxane, and the dimethyl, diethyl or di-n-butyl ethers of ethylene glycol, diethylene glycol, triethylene glycol, propylene glycol, dipropylene glycol or tripropylene glycol.

Ketones are, for example, acetone, 2-butanone, 2-pentanone, 3-pentanone, hexanone, isobutyl methyl ketone, heptanone, cyclopentanone, cyclohexanone or cycloheptanone.

(Cyclo)aliphatic hydrocarbons are, for example, decalin, alkylated decalin, and isomer mixtures of linear or branched alkanes and/or cycloalkanes.

Additionally preferred are n-butyl acetate, ethyl acetate, 1-methoxyprop-2-yl acetate, 2-methoxyethyl acetate, 2-butanone, isobutyl methyl ketone, and mixtures thereof, particularly with the aromatic hydrocarbon mixtures set out above.

Mixtures of this kind can be made up at a volume ratio of 5:1 to 1:5, preferably at a volume ratio of 4:1 to 1:4, more preferably at a volume ratio of 3:1 to 1:3, and very particularly preferably at a volume ratio of 2:1 to 1:2.

Preferred solvents are butyl acetate, methoxypropyl acetate, isobutyl methyl ketone, 2-butanone, Solvesso® grades, and xylene.

Additionally suitable for the carbonates may be, for example, water, alcohols, such as methanol, ethanol, butanol, alcohol/water mixtures, acetone, 2-butanone, dimethyl-formamide, dimethylacetamide, N-methylpyrrolidone, N-ethylpyrrolidone, ethylene carbonate or propylene carbonate.

More preferably the polycarbonates are water-soluble or water-dispersible.

By a high-functionality polycarbonate is meant in the context of this invention a product which besides the carbonate groups which form the polymer backbone has terminally or pendently in addition at least three, preferably at least six, more preferably at least ten functional groups. The functional groups are carbonate groups or carbamoyl chloride groups and/or OH groups. In principle there is no upper limit on the number of terminal or pendent functional groups; however, products having a very high number of functional groups may exhibit unwanted properties, such as high viscosity or poor solubility, for example. The high-functionality polycarbonates generally have no more than 500 terminal or pendent functional groups, preferably not more than 100 terminal or pendent functional groups.

For the preparation of the high-functionality polycarbonates it is necessary to set the ratio of the OH-comprising compounds to phosgene or carbonate (A) such that the resultant simplest condensation product (called condensation product (K) below) comprises on average either one carbonate or carbamoyl chloride group and more than one OH group or one OH group and more than one carbonate or carbamoyl chloride group, preferably on average either one carbonate or carbamoyl chloride group and at least two OH groups or one OH group and at least two carbonate or carbamoyl chloride groups.

It may further be sensible, for fine-tuning the properties of the polycarbonate, to use at least one divalent carbonyl-reactive compound (A1). By this are meant compounds which contain two carbonate and/or carboxyl groups.

Carboxyl groups can in this context be carboxylic acids, carbonyl chlorides, carboxylic anhydrides or carboxylic esters, preferably carboxylic anhydrides or carboxylic esters, and more preferably carboxylic esters.

If such divalent compounds (A1) are used, then the ratio of (A1) to the carbonates and/or phosgenes (A) is laid down by the skilled worker in accordance with the desired properties of the polycarbonate. As a general rule the amount of the divalent compound or compounds (A1) is 0 to 40 mol %, based on the total amount of all carbonates/phosgenes (A) and compounds (A1) together. Preferably the amount is 0 to 35 mol %, more preferably 0 to 25 mol %, and very preferably 0 to 10 mol %.

Examples of compounds (A1) are dicarbonates or dicarbamoyl chlorides of diols, examples of which are ethylene glycol, 1,2-propanediol, 1,3-propanediol, 1,1-dimethyl-ethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)iso-propylidene, tetramethylcyclobutanediol, 1,2-, 1,3- or 1,4-cyclohexanediol, cyclo-octanediol, norbornanediol, pinanediol, decalindiol, 2-ethyl-1,3-hexanediol, 2,4-diethyl-octane-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclohexanedimethanol, and 1,2-, 1,3- or 1,4-cyclohexanediol.

These compounds may be prepared, for example, by reacting said diols with an excess of, for example, the above-recited carbonates RO(CO)OR or chlorocarbonic esters, so that the dicarbonates thus obtained are substituted on both sides by groups RO(CO)—. A further possibility is to react the diols first with phosgene to give the corresponding chlorocarbonic esters of the diols, and then to react these esters with alcohols.

Further compounds (A1) are dicarboxylic acids, esters of dicarboxylic acids, preferably the methyl, ethyl, isopropyl, n-propyl, n-butyl, isobutyl, sec-butyl or tert-butyl esters, more preferably the methyl, ethyl or n-butyl esters.

Examples of dicarboxylic acids of this kind are oxalic acid, maleic acid, fumaric acid, succinic acid, glutaric acid, adipic acid, sebacic acid, dodecanedioic acid, o-phthalic acid, isophthalic acid, terephthalic acid, azelaic acid, 1,4-cyclohexanedicarboxylic acid or tetrahydrophthalic acid, suberic acid, phthalic anhydride, tetrahydrophthalic anhydride, hexahydrophthalic anhydride, tetrachlorophthalic anhydride, endomethylenetetrahydrophthalic anhydride, glutaric anhydride, dimeric fatty acids, isomers thereof and hydrogenation products thereof.

The simplest structure of the condensation product (K), illustrated using, as example, the reaction of a carbonate (A) with a dialcohol or polyalcohol (B), produces the arrangement XYₘ or YₘX, X being a carbonate or carbamoyl group, Y a hydroxyl group, and m generally an integer greater than 1 to 6, preferably greater than 1 to 4, more preferably greater than 1 to 3. The reactive group, which results as a single group, is generally referred to below as “focal group”.

Where, for example, in the preparation of the simplest condensation product (K) from a carbonate and a dihydric alcohol, the molar reaction ratio is 1:1, then the result on average is a molecule of type XY, illustrated by the general formula (I).

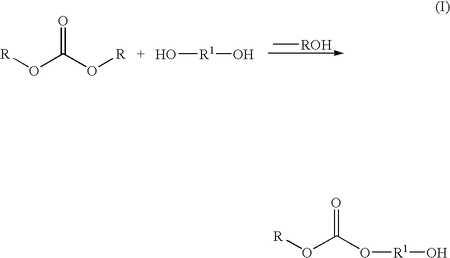

In the case of the preparation of the condensation product (K) from a carbonate and a trihydric alcohol with a molar reaction ratio of 1:1, the result on average is a molecule of type XY₂, illustrated by the general formula (II). The focal group here is a carbonate group.

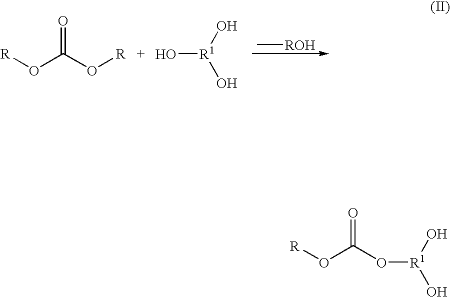

In the preparation of the condensation product (K) from a carbonate and a tetrahydric alcohol, again with the molar reaction ratio 1:1, the result on average is a molecule of type XY₃, illustrated by the general formula (III). The focal group here is a carbonate group.

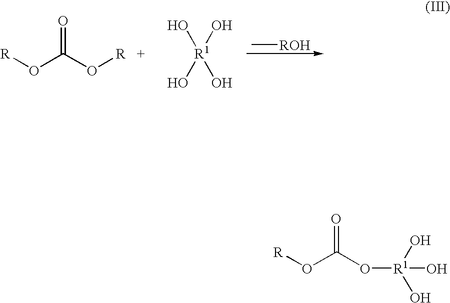

In the formulae (I) to (III) R is as defined at the outset and R¹ is an aliphatic or aromatic radical.

The condensation product (K) can also be prepared, for example, from a carbonate and a trihydric alcohol, illustrated by the general formula (IV), where the reaction ratio on a molar basis is 2:1. Here the result on average is a molecule of type X₂Y, the focal group here being an OH group. In the formula (IV) the definitions of R and R′ are the same as above in formulae (I) to (III).

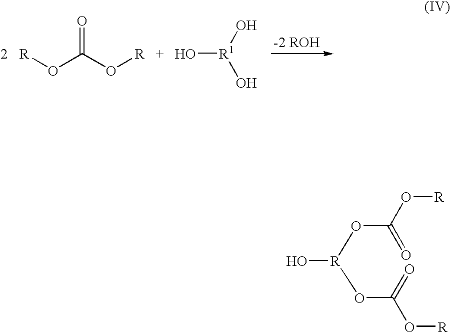

Where difunctional compounds, e.g., a dicarbonate or a diol, are additionally added to the components, this produces an extension of the chains, as illustrated for example in the general formula (V). The result again is on average a molecule of type XY₂, the focal group being a carbonate group.

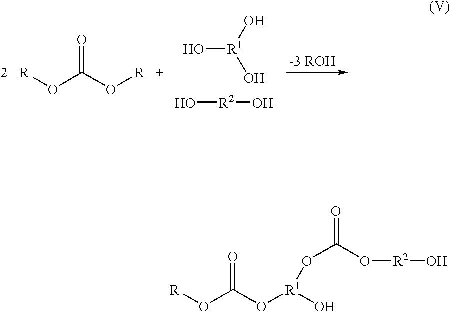

In formula (V) R² is an aliphatic or aromatic radical, while R and R¹ are defined as described above.

It is also possible to use two or more condensation products (K) for the synthesis. In this case it is possible on the one hand to use two or more alcohols and/or two or more carbonates. Furthermore, through the choice of the ratio of the alcohols and carbonates or phosgenes used, it is possible to obtain mixtures of different condensation products with different structure. This may be exemplified taking, as example, the reaction of a carbonate with a trihydric alcohol. If the starting products are used in a 1:1 ratio, as depicted in (II), a molecule XY₂ is obtained. If the starting products are used in a 2:1 ratio, as illustrated in (IV), the result is a molecule X₂Y. With a ratio between 1:1 and 2:1 a mixture of molecules XY₂ and X₂Y is obtained.

Typical reaction conditions for the reaction of (A) with (B) to form the condensation product (K) are set out below:

The stoichiometry of components (A) and (B) is generally chosen such that the resultant condensation product (K) contains on average either one carbonate or carbamoyl chloride group and more than one OH group, or one OH group and more than one carbonate or carbamoyl chloride group. This is achieved in the first case by a stoichiometry of 1 mol of carbonate groups: >2 mol of OH groups, for example, a stoichiometry of 1:2.1 to 8, preferably 1:2.2 to 6, more preferably 1:2.5 to 4, and very preferably 1:2.8 to 3.5.

In the second case it is achieved by a stoichiometry of more than 1 mol of carbonate groups: <1 mol of OH groups, for example, a stoichiometry of 1:0.1 to 0.48, preferably 1:0.15 to 0.45, more preferably 1:0.25 to 0.4, and very preferably 1:0.28 to 0.35.

The temperature ought to be sufficient for the reaction of the alcohol with the corresponding carbonyl component. For the reaction with a phosgene a temperature is generally from −20° C. to 120° C., preferably 0 to 100° C., and more preferably 20 to 80° C. When a carbonate is used the temperature should be 60 to 180° C., preferably 80 to 160° C., more preferably 100 to 160° C., and very preferably 120 to 140° C.

Suitable solvents are those already set out above. A preferred embodiment is to carry out the reaction without solvent.

The order in which the individual components is added is generally of minor importance. As a general rule it is sensible to introduce the excess component of the two reaction partners first and to add the deficit component. Alternatively it is likewise possible to mix the two components with one another before the beginning of reaction and then to heat this mixture to the requisite reaction temperature.

The simple condensation products (K) described exemplarily in formulae (I) to (V) react preferably intermolecularly to form high-functionality polycondensation products, referred to below as polycondensation products (P). The reaction to give the condensation product (K) and to give the polycondensation product (P) takes place usually at a temperature of 0 to 300° C., preferably 0 to 250° C., more preferably at 60 to 200° C., and very preferably at 60 to 160° C., in bulk (without solvent) or in solution. In this context it is possible generally to use any solvents which are inert toward the respective reactants. Preference is given to using organic solvents, such as those mentioned above, for example, and more preferably decane, dodecane, benzene, toluene, chlorobenzene, xylene, dimethylformamide, dimethylacetamide or solvent naphtha.

In one preferred embodiment the condensation reaction is carried out in bulk. The monofunctional alcohol or the phenol which is liberated during the reaction, ROH, can be removed from the reaction equilibrium in order to accelerate the reaction, such removal taking place, for example, by distillative means, if appropriate under reduced pressure.

The separation of the alcohol or phenol can also be assisted by passing through the reaction mixture a stream of gas which is substantially inert under the reaction conditions (i.e., stripping), such as, for example, nitrogen, steam, carbon dioxide, or else by passing through the mixture an oxygen-containing gas, such as atmospheric air or lean air, for example.

If distillative removal is intended, it is advisable as a general rule to use carbonates which during the reaction give off alcohols or phenols ROH having a boiling point of less than 140° C. under the prevailing pressure.

To accelerate the reaction it is also possible to add catalysts or catalyst mixtures. Suitable catalysts are compounds which catalyze esterification or transesterification reactions, examples being alkali metal hydroxides, alkali metal carbonates, alkali metal hydrogen carbonates, preferably of sodium, of potassium or of cesium, tertiary amines, guanidines, ammonium compounds, phosphonium compounds, organoaluminum, organotin, organozinc, organotitanium, organozirconium or organobismuth compounds, and also catalysts of the kind known as double metal cyanide (DMC) catalysts, as described, for example, in DE 10138216 or in DE 10147712.

Preference is given to using potassium hydroxide, potassium carbonate, potassium hydrogen carbonate, diazabicyclooctane (DABCO), diazabicyclononene (DBN), diazabicycloundecene (DBU), imidazoles, such as imidazole, 1-methylimidazole or 1,2-dimethylimidazole, titanium tetrabutoxide, titanium tetraisopropoxide, dibutyltin oxide, dibutyltin dilaurate, tin dioctoate, zirconium acetylacetonate, or mixtures thereof.

The catalyst is generally added in an amount of 50 to 10 000 ppm by weight, preferably of 100 to 5000 ppm by weight, based on the amount of alcohol or alcohol mixture employed.

Furthermore it is also possible, either by adding the appropriate catalyst and/or by choosing a suitable temperature, to control the intermolecular polycondensation reaction. In addition the average molecular weight of the polymer (P) can be adjusted via the composition of the starting components and via the residence time.

The condensation products (K) and the polycondensation products (P), which have been prepared at an elevated temperature, are stable at room temperature usually for a relatively long period of time, for example, for at least 6 weeks, without displaying turbidities, precipitations and/or any increase in viscosity.

In view of the nature of the condensation products (K) it is possible that the condensation reaction may result in polycondensation products (P) having different structures, with branches but no crosslinks. Furthermore, the polycondensation products (P) ideally contain either a carbonate or carbamoyl chloride focal group and more than two OH groups, or else an OH focal group and more than two carbonate or carbamoyl chloride groups. The number of reactive groups depends on the nature of the condensation products (K) employed and on the degree of polycondensation.

For example, a condensation product (K) of the general formula (II) may react by triple intermolecular condensation to form two different polycondensation products (P), which are reproduced in the general formulae (VI) and (VII).

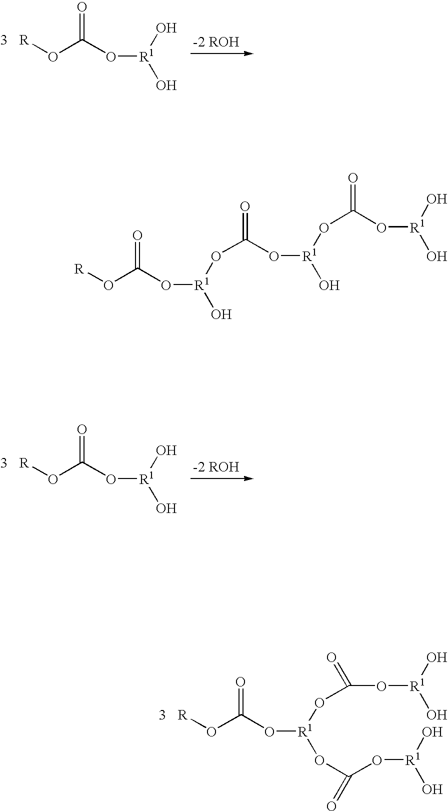

R and R¹ in formulae (VI) and (VII) are as defined above.

To terminate the intermolecular polycondensation reaction there are a variety of possibilities. By way of example the temperature can be lowered to a range in which the reaction comes to a standstill and the product (K) or the polycondensation product (P) is stable on storage. This is generally the case at below 60° C., preferably below 50° C., more preferably below 40° C., and very preferably at room temperature.

Furthermore, the catalyst can be deactivated—in the case of basic catalysts, for example, by adding an acidic component, a Lewis acid for example, or an organic or inorganic protic acid.

A further possibility is to arrest the reaction by dilution with a precooled solvent. This is particularly preferred when it is necessary to adapt the viscosity of the reaction mixture by adding solvent.

In a further embodiment, as soon as the intermolecular reaction of the condensation product (K) gives a polycondensation product (P) having the desired degree of polycondensation, the reaction can be arrested by adding to the product (P) a product having groups that are reactive toward the focal group of (P).

For instance, in the case of a carbonate or carbamoyl focal group, a mono-, di- or polyamine, for example, can be added.

In the case of a hydroxyl focal group, the product (P) can have added to it, for example, a mono-, di- or polyisocyanate, a compound comprising epoxide groups, or an acid derivative which is reactive with OH groups.

The high-functionality polycarbonates are generally prepared in a pressure range from 0.1 hPa to 2 MPa, preferably 1 hPa to 500 kPa, in reactors or reactor cascades which are operated batchwise, semibatchwise or continuously.

As a result of the aforementioned setting of the reaction conditions and, if appropriate, as a result of the choice of suitable solvent, the products can be processed further following preparation, without additional purification.

If necessary, the reaction mixture can be subjected to decoloring, by means for example of treatment with activated carbon or metal oxides, such as alumina, silica, magnesium oxide, zirconium oxide, boron oxide or mixtures thereof, in amounts for example of 0.1%-50%, preferably 0.5% to 25%, more preferably 1%-10%, by weight, at temperatures of, for example, 10 to 100° C., preferably 20 to 80° C., and more preferably 30 to 60° C.

If appropriate it is also possible to filter the reaction mixture in order to remove any precipitates present.

In a further preferred embodiment the product is stripped, i.e., freed from volatile compounds of low molecular weight. For this purpose, after the desired degree of conversion has been reached, the catalyst can be optionally deactivated and the volatile constituents of low molecular weight, such as monoalcohols, phenols, carbonates, hydrogen chloride or volatile oligomeric or cyclic compounds, can be removed by distillation, if appropriate accompanied by introduction of a gas, preferably nitrogen, carbon dioxide or air, if appropriate under reduced pressure.

In a further preferred embodiment the polycarbonates may maintain not only the functional groups already maintained by virtue of the reaction but also further functional groups. Functionalization can in this case take place during the buildup of molecular weight or else subsequently, i.e., after the end of the actual polycondensation.

If, before or during the buildup of molecular weight, components are added which besides hydroxyl or carbonate groups possess further functional groups or functional elements, then a polycarbonate polymer is obtained which has randomly distributed functionalities different from the carbonate or carbamoyl chloride and hydroxyl groups.

Effects of this kind can be achieved for example by adding, during the polycondensation, compounds which in addition to hydroxyl, carbonate or carbamoyl chloride groups carry further functional groups or functional elements, such as mercapto groups, primary, secondary or tertiary amino groups, ether groups, carboxylic acid groups or derivatives thereof, sulfonic acid groups or derivatives thereof, phosphonic acid groups or derivatives thereof, silane groups, siloxane groups, aryl radicals or long-chain alkyl radicals.

For modification by means of carbamate groups it is possible for example to use ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)amino-methane, tris(hydroxyethyl)aminomethane, ethylenediamine, propylenediamine, hexamethylenediamine or isophoronediamine.

For modification with mercapto groups it is possible to use mercaptoethanol for example. Tertiary amino groups can be generated, for example, by incorporation of triethanolamine, tripropanolamine, N-methyldiethanolamine, N-methyldipropanolamine or N,N-dimethylethanolamine. Ether groups can be generated, for example, by incorporating polyetherols having a functionality of two or more during condensation. By adding dicarboxylic acids, tricarboxylic acids, dicarboxylic esters, such as dimethyl terephthalate, or tricarboxylic esters, it is possible to generate ester groups. Reaction with long-chain alkanols or alkanediols enables long-chain alkyl radicals to be incorporated. Reaction with alkyl or aryl diisocyanates generates polycarbonates containing alkyl, aryl, and urethane groups, while addition of primary or secondary amines results in the incorporation of urethane or urea groups.

Subsequent functionalization can be obtained by reacting the resultant high-functionality highly branched or hyperbranched polycarbonate in an additional process step (step c)) with a suitable functionalizing reagent that is able to react with the polycarbonate's OH and/or carbonate or carbamoyl chloride groups.

High-functionality, highly branched or hyperbranched polycarbonates comprising hydroxyl groups can be modified, for example, by adding molecules comprising acid groups or isocyanate groups. Polycarbonates comprising acid groups, for example, can be obtained by reaction with compounds comprising anhydride groups.

Additionally, high-functionality polycarbonates comprising hydroxyl groups can also be converted into high-functionality polycarbonate-polyetherpolyols by reaction with alkylene oxides-ethylene oxide, propylene oxide or butylene oxide, for example.

This may be sensible in order, for example, to increase the solubility in water or to produce emulsifiability in water. For these purposes the hydroxyl groups are reacted with at least one alkylene oxide, such as ethylene oxide, propylene oxide, isobutylene oxide and/or styrene oxide, preferably ethylene oxide and/or propylene oxide, and more preferably ethylene oxide. For this purpose, for each hydroxyl group, 1 to 200, preferably 2 to 200, more preferably 5 to 100, very preferably 10 to 100, and in particular 20 to 50 alkylene oxides are employed.

In one preferred embodiment of the present invention the polycarbonates are reacted at least partly with at least one monofunctional polyalkylene oxide polyether alcohol. This produces improved emulsifiability in water.

Monofunctional polyalkylene oxide polyether alcohols are reaction products of suitable starter molecules with polyalkylene oxides.

Suitable starter molecules for preparing monohydric polyalkylene oxide polyether alcohols are thiol compounds, monohydroxy compounds of the general formula

R⁵—O—H

or secondary monoamines of the general formula

R⁶R⁷N—H,

in which

R⁵, R⁶, and R⁷ independently of one another are independently of one another in each case C₁-C₁₈ alkyl, C₂-C₁₈ alkyl interrupted if appropriate by one or more oxygen and/or sulfur atoms and/or by one or more substituted or unsubstituted imino groups, C₆-C₁₂ aryl, C₅-C₁₂ cycloalkyl or a five- to six-membered heterocycle containing oxygen, nitrogen and/or sulfur atoms, or R⁶ and R⁷ together form an unsaturated, saturated or aromatic ring which is interrupted if appropriate by one or more oxygen and/or sulfur atoms and/or by one or more substituted or unsubstituted imino groups, it being possible for each of said radicals to be substituted by functional groups, aryl, alkyl, aryloxy, alkyloxy, halogen, heteroatoms and/or heterocycles.

Preferably R⁵, R⁶, and R⁷ independently of one another are C₁ to C₄ alkyl, i.e., methyl, ethyl, isopropyl, n-propyl, n-butyl, isobutyl, sec-butyl or tert-butyl, and more preferably R⁵, R⁶, and R⁷ are methyl.

Examples of suitable monohydric starter molecules may be saturated monoalcohols such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, cyclopentanol, the isomeric methylcyclohexanols or hydroxymethylcyclohexane, 3-ethyl-3-hydroxymethyloxetane, or tetrahydrofurfuryl alcohol; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, di-n-butylamine, diisobutylamine, bis(2-ethylhexyl)amine, N-methyl- and N-ethylcyclohexylamine or dicyclohexylamine, heterocyclic secondary amines such as morpholine, pyrrolidine, piperidine or 1H-pyrazole, and also amino alcohols such as 2-dimethylaminoethanol, 2-diethyl-aminoethanol, 2-diisopropylaminoethanol, 2-dibutylaminoethanol, 3-(dimethylamino)-1-propanol or 1-(dimethylamino)-2-propanol.

Examples of the polyethers prepared starting from amines are the products known as Jeffamine® M series, which are methyl-capped polyalkylene oxides containing an amino function, such as M-600 (XTJ-505), with a propylene oxide (PO)/ethylene oxide (EO) ratio of approximately 9:1 and a molar mass of about 600, M-1000 (XTJ-506):PO/EO ratio 3:19, molar mass approximately 1000, M-2005 (XTJ-507):PO/EO ratio 29:6, molar mass approximately 2000 or M-2070:PO/EO ratio 10:31, molar mass approximately 2000.

Alkylene oxides suitable for the alkoxylation reaction are ethylene oxide, propylene oxide, isobutylene oxide, vinyloxirane and/or styrene oxide, which may be used in any order or else in a mixture for the alkoxylation reaction.

Preferred alkylene oxides are ethylene oxide, propylene oxide, and mixtures thereof; ethylene oxide is particularly preferred.

Preferred polyether alcohols are those based on polyalkylene oxide polyether alcohols prepared using saturated aliphatic or cycloaliphatic alcohols of the above mentioned kind as starter molecules. Very particular preference is given to those based on polyalkylene oxide polyether alcohols which have been prepared using saturated aliphatic alcohols having 1 to 4 carbon atoms in the alkyl radical. Particular preference is given to polyalkylene oxide polyether alcohols prepared starting from methanol.

The monohydric polyalkylene oxide polyether alcohols contain on average in general at least 2 alkylene oxide units, preferably 5 ethylene oxide units, per molecule, more preferably at least 7, very preferably at least 10, and in particular at least 15.

The monohydric polyalkylene oxide polyether alcohols contain on average in general up to 50 alkylene oxide units, preferably ethylene oxide units, per molecule, preferably up to 45, more preferably up to 40, and very preferably up to 30.

The molar weight of the monohydric polyalkylene oxide polyether alcohols is preferably up to 4000, more preferably not above 2000 g/mol, very preferably not below 500, and in particular 1000±200 g/mol.

Preferred polyether alcohols are therefore compounds of the formula

R⁵—O—[—Xᵢ-]ₖ—H

in which

R⁵ is as defined above,

k is an integer from 5 to 40, preferably 7 to 45, and more preferably 10 to 40, and each Xᵢ for i=1 to k can be selected independently of the others from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group consisting of —CH₂—CH₂—O—, —CH₂—CH(CH₃)—O—, and —CH(CH₃)—CH₂—O—, and more preferably —CH₂—CH₂—O—

where Ph is phenyl and Vin is vinyl.

To carry out the reaction of the polycarbonates the polycarbonates (K) and/or (P) are reacted with one another at temperatures of 40 to 180° C., preferably 50 to 150° C., observing a carbonate or carbamoyl chloride/OH equivalent ratio of 1:1 to 100:1, preferably of 1:1 to 50:1, more preferably 1.5:1 to 20:1.

A great advantage of the process lies in its economy. Both the reaction to form a condensation product (K) or polycondensation product (P) and the reaction of (K) or (P) to form polycarbonates with other functional groups or elements can take place in one reaction apparatus, which is an advantage both technically and economically.

The high-functionality highly branched polycarbonates formed by the process are terminated after the reaction—that is, without further modification—by hydroxyl groups and/or by carbonate or carbamoyl chloride groups. They dissolve readily in various solvents, for example, in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate.

The high-functionality, highly branched or hyperbranched polycarbonates are used in a proportion of 0.1% to 15%, preferably 0.2% to 10%, more preferably 0.3 to 8%, very preferably 0.4% to 5%, and more particularly 0.5% to 3%, by weight, based on the solids content of the aqueous basecoat materials.

The aqueous basecoat materials of the invention may comprise typical coating solvents, in a proportion, for example, of preferably below 20% by weight, more preferably below 15% by weight.

The solvents in question are typical coatings solvents, and may originate, for example, from the preparation of the binders or the polycarbonates, or are added separately. Examples of such solvents are monohydric or polyhydric alcohols, e.g., propanol, butanol, hexanol; glycol ethers or glycol esters, examples being diethylene glycol di-C₁-C₈ alkyl ethers, dipropylene glycol di-C₁-C₈ alkyl ethers, ethoxypropanol, butyl glycol; glycols, e.g., ethylene glycol and/or propylene glycol, and their dimers or trimers, N-alkylpyrrolidones, such as N-methylpyrrolidone, for example, and also ketones such as methyl ethyl ketone, acetone, and cyclohexanone; aromatic or aliphatic hydrocarbons, such as toluene and xylene, or linear or branched aliphatic C₆-C₁₂ hydrocarbons.

The aqueous basecoat materials of the invention possess solids contents, for example, of 10% to 50% by weight; for effect aqueous basecoat materials the figure is, for example, preferably 15% to 30% by weight; for solid-color aqueous basecoat materials it is preferably higher, at 20% to 45% by weight, for example.

In the calculation of the ratio of pigment to binder, the sum of the weight fractions of coloring pigments, effect pigments and/or fillers is related to the sum of the weight fractions of solid binder, solid paste resin, and solid crosslinker in the complete aqueous basecoat material.

The aqueous basecoat materials of the invention, further to the hyperbranched polycarbonates, additionally comprise at least one binder (O) and at least one crosslinker (V). Optionally the aqueous basecoat materials may further comprise additional additives (F), and/or color and/or effect pigments (G).

The aqueous basecoat materials suitably comprise ionically or nonionically stabilized binder systems. These systems are preferably anionically and/or nonionically stabilized.

Anionic stabilization is achieved preferably by means of at least partially neutralized carboxyl groups in the binder, while nonionic stabilization is achieved preferably by lateral or terminal polyalkylene oxide units, especially polyethylene oxide units, in the binder.

The aqueous basecoat materials may be physically drying in nature or may be crosslinkable with formation of covalent bonds. In the case of the aqueous basecoat materials that crosslink with formation of covalent bonds, the systems in question may be self-crosslinking or externally crosslinking systems. In the latter case they may be one-component or multicomponent aqueous basecoat materials.

The aqueous basecoat materials of the invention comprise one or more typical film-forming binders. If the binders are not self-crosslinking or self-drying, they may if appropriate also comprise crosslinkers. Not only the binder component but also the crosslinker component, where present, is not subject to any restriction whatsoever.

Examples of film-forming binders which can be used include typical polyester, polyurethane and/or poly(meth)acrylate resins. The selection of the crosslinkers, where present, is not critical, and is guided, in a manner familiar to the skilled worker, by the functionality of the binders—that is, the crosslinkers are selected such that they exhibit a reactive functionality which is complementary to the functionality of the binders.

Examples of such complementary functionalities between binder and crosslinker are as follows: carboxyl/epoxide, hydroxyl/methylol ether and/or methylol (methylol ether and/or methylol preferably as crosslinking-active groups of amino resins), hydroxyl/free isocyanate, hydroxyl/blocked isocyanate, (meth)acryloyl/CH-acidic group. Where they are compatible with one another, it is also possible for two or more such complementary functionalities to be present alongside one another in one aqueous basecoat material. The crosslinkers present if appropriate in the aqueous basecoat materials may be present individually or in a mixture.

Examples of suitable complementary reactive functional groups of binder and crosslinker, for use in accordance with the invention, are assembled in the overview below. In the overview the variable R⁸ stands for an acyclic or cyclic aliphatic radical, an aromatic and/or an aromatic-aliphatic (araliphatic) radical; the variables R⁹ and R¹⁰ stand for identical or different aliphatic radicals or are linked with one another to form an aliphatic or heteroaliphatic ring.

### Overview: Examples of Complementary Reactive Functional Groups

| | | |
|---|---|---|
| Binder | and | Crosslinking agent |
| | or | |
| Crosslinking agent | and | Binder |

| | |
|---|---|
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R⁸ |
| | —NH—CH₂—O—R⁸ |
| | —NH—CH₂—OH |
| | —N(—CH₂—O—R⁸)₂ |
| | —NH—C(O)—CH(—C(O)OR⁸)₂ |
| | —NH—C(O)—CH(—C(O)OR⁸)(—C(O)—R⁸) |
| | —NH—C(O)—NR⁹R¹⁰ |
| | >Si(OR⁸)₂ |
| | 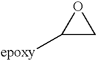 |
| | 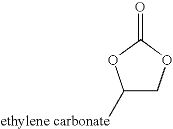 |
| —C(O)—OH | 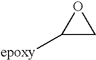 |
| | —C(O)—N(CH₂—CH₂—OH)₂ |

Complementary reactive functional groups especially suitable for use in the aqueous basecoat materials of the invention are
carboxyl groups on the one hand and epoxide groups and/or beta-hydroxyalkylamide groups on the other, and also
hydroxyl groups on the one hand and blocked and unblocked isocyanate groups or urethane or alkoxymethylamino groups on the other.

Suitable binder components (O) include, for example, together if appropriate with other hydroxyl- or amino-containing binders, hydroxy (meth)acrylates, hydroxystyryl (meth)acrylates, linear or branched polyesters, polyethers, polycarbonates, melamine resins or urea-formaldehyde resins, together with crosslinking compounds that are reactive toward carboxyl and/or hydroxyl functions, such as for example with isocyanates, blocked isocyanates, epoxides and/or amino resins, preferably isocyanates, epoxides or amino resins, more preferably with isocyanates or epoxides, and very preferably with isocyanates.

As binders (O) it is possible to employ any desired oligomeric or polymeric resins. By oligomers are meant resins which comprise at least 2 to 15 monomer units in their molecule. For the purposes of the present invention polymers are resins which comprise at least 10 repeating monomer units in their molecule. For further details of these terms refer to Römpp Lexikon Lacke und Druckfarben, Georg Thieme Verlag, Stuttgart, New York, 1998, “Oligomers”, page 425.

Examples of suitable constituents (O) are random, alternating and/or block, linear and/or branched and/or comb (co)polymers of ethylenically unsaturated monomers, or polyaddition resins and/or polycondensation resins. For further details of these terms refer to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation”, and “Polycondensation resins”, and also pages 73 and 74, “Binders”.

Examples of suitable (co)polymers are (meth)acrylate (co)polymers or partially hydrolyzed polyvinyl esters, especially (meth)acrylate copolymers, particularly with vinylaromatics.

Examples of suitable polyaddition resins and/or polycondensation resins are polyesters, alkyds, amino resins, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyester-polyurethanes.

The constituents (O) may be noncrosslinkingly or physically crosslinkingly thermoplastic, thermally self-crosslinking or externally crosslinking. In addition they may be curable thermally and/or with actinic radiation. The combined application of thermal curing and of curing with actinic radiation is also referred to by those in the art as dual cure.

The self-crosslinking binders (O) of the thermally curable aqueous basecoat materials and of the dual-cure aqueous basecoat materials comprise reactive functional groups which are able to enter into crosslinking reactions with groups of their own kind or with complementary reactive functional groups. The externally crosslinking binders comprise reactive functional groups which are able to enter into crosslinking reactions with complementary reactive functional groups present in crosslinking agents. Examples of suitable complementary reactive functional groups for use in accordance with the invention are those described above. In this case components (O) and (V) are united in one compound.

The functionality of the self-crosslinking and/or of the externally crosslinking constituents (O) with respect to the reactive functional groups described above may vary very widely and is guided in particular by the target crosslinking density and/or by the functionality of the crosslinking agents employed in each case. By way of example, in the case of carboxyl-containing constituents (O), the acid number is preferably 10 to 100, more preferably 15 to 80, very preferably 20 to 75, with very particular preference 25 to 70, and in particular 30 to 65 mg KOH/g. Or in the case of hydroxyl-containing constituents (O) the OH number is preferably 15 to 300, more preferably 20 to 250, very preferably 25 to 200, with very particular preference 30 to 150, and in particular 35 to 120 mg KOH/g. Or in the case of constituents (O) containing epoxide groups the epoxide equivalent weight is preferably 400 to 2500, more preferably 420 to 2200, very preferably 430 to 2100, with very particular preference 440 to 2000, and in particular 440 to 1900.

The above-described complementary functional groups can be incorporated into the binders in accordance with the customary and known methods of polymer chemistry. This can take place, for example, by the incorporation of monomers which carry the corresponding reactive functional groups, and/or with the aid of polymer-analogous reactions.

Examples of suitable olefinically unsaturated monomers with reactive functional groups are
c1) monomers which carry at least one hydroxyl, amino, alkoxymethylamino, carbamate, allophanate or imino group per molecule such as
   hydroxyalkyl esters of acrylic acid, methacrylic acid or another alpha,beta-olefinically unsaturated carboxylic acid, which derive from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group comprises up to 20 carbon atoms, such as 2-hydroxyethyl, 2-hydroxypropyl, 3-hydroxypropyl, 3-hydroxybutyl, and 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indene-dimethanol or methylpropanediol monoacrylate, monomethacrylate, monoethacrylate, monocrotonate, monomaleate, monofumarate or monoitaconate; reaction products of cyclic esters, such as epsilon-caprolactone, for example, and these hydroxyalkyl or hydroxycycloalkyl esters;
   olefinically unsaturated alcohols such as allyl alcohol;
   polyols such as trimethylolpropane monoallyl or diallyl ether or pentaerythritol monoallyl, diallyl or triallyl ether;
   reaction products of acrylic acid and/or methacrylic acid with the glycidyl ester of an alpha-branched monocarboxylic acid having 5 to 18 carbon atoms per molecule, in particular a Versatic® acid, or, instead of the reaction product, an equivalent amount of acrylic acid and/or methacrylic acid, which is then reacted, during or after the polymerization reaction, with the glycidyl ester of an alpha-branched monocarboxylic acid having 5 to 18 carbon atoms per molecule, in particular a Versatic® acid;
   aminoethyl acrylate, aminoethyl methacrylate, allylamine or N-methyliminoethyl acrylate;
   N,N-di(methoxymethyl)aminoethyl acrylate or methacrylate or N,N-di(butoxymethyl)aminopropyl acrylate or methacrylate;
   (meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)(meth)acrylamide;
   acryloyloxy- or methacryloyloxyethyl, -propyl or -butyl carbamate or allophanate; further examples of suitable monomers comprising carbamate groups are described in patents U.S. Pat. No. 3,479,328, U.S. Pat. No. 3,674,838 A, U.S. Pat. No. 4,126,747 A, U.S. Pat. No. 4,279,833 A or U.S. Pat. No. 4,340,497 A;
c2) monomers which carry at least one acid group per molecule, such as
   acrylic acid, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleate, succinate or phthalate; or
   vinylbenzoic acid (all isomers), alpha-methylvinylbenzoic acid (all isomers) or vinylbenzenesulfonic acid (all isomers),
c3) monomers comprising epoxide groups, such as the glycidyl ester of acrylic acid, methacrylic acid, ethacrylic acid, crotonic acid, maleic acid, fumaric acid or itaconic acid, or allyl glycidyl ether.

They are used preferably for preparing the preferred (meth)acrylate copolymers, especially those containing glycidyl groups.

Higher polyfunctional monomers of the type described above are generally used in minor amounts. For the purposes of the present invention minor amounts of higher polyfunctional monomers are amounts which do not lead to crosslinking or gelling of the copolymers, particularly of the (meth)acrylate copolymers, unless the specific intention is to produce crosslinked polymeric microparticles.

Examples of suitable monomer units for introducing reactive functional groups into polyesters or polyester-polyurethanes are 2,2-dimethylolethyl- or -propylamine, which have been blocked with a ketone, the resulting ketoxime group being hydrolyzed again after incorporation; or compounds which comprise two hydroxyl groups or two primary and/or secondary amino groups and also at least one acid group, in particular at least one carboxyl group and/or at least one sulfonic acid group, such as dihydroxypropionic acid, dihydroxysuccinic acid, dihydroxybenzoic acid, 2,2-dimethylolacetic acid, 2,2-dimethylolpropionic acid, 2,2-dimethylolbutyric acid, 2,2-dimenthylolpentanoic acid, diaminovaleric acid, 3,4-diaminobenzoic acid, 2,4-diaminotoluenesulfonic acid or 2,4-diaminodiphenyl ether sulfonic acid.

One example of the introduction of reactive functional groups via polymer-analogous reactions is the reaction of resins comprising hydroxyl groups with phosgene, resulting in resins comprising chloroformate groups, and the polymer-analogous reaction of the resins comprising chloroformate groups with ammonia and/or primary and/or secondary amines to give resins comprising carbamate groups. Further examples of suitable methods of this kind are known from patents U.S. Pat. No. 4,758,632 A, U.S. Pat. No. 4,301,257 A or U.S. Pat. No. 2,979,514 A.

The constituents (O) which are crosslinkable by actinic radiation or by dual cure comprise on average at least one, preferably at least two, group(s) having at least one bond per molecule that can be activated with actinic radiation.

For the purposes of the present invention a bond which can be activated with actinic radiation is a bond which when irradiated with actinic radiation becomes reactive and enters, with other activated bonds of its kind, into polymerization reactions and/or crosslinking reactions which proceed in accordance with free-radical and/or ionic mechanisms. Examples of suitable bonds are single carbon-hydrogen bonds or single or double carbon-carbon, carbon-oxygen, carbon-nitrogen, carbon-phosphorus or carbon-silicon bonds. Among these the double carbon-carbon bonds are particularly advantageous and are therefore used with very particular preference. For the sake of brevity they are referred to below as “double bonds”.

Accordingly the preferred group comprises one double bond or two, three or four double bonds. Where more than one double bond is used, the double bonds can be conjugated. It is of advantage if the double bonds are isolated, in particular each terminally, in the group in question here. In accordance with the invention it is of particular advantage to use two, in particular one, double bond(s).

Where on average more than one group which can be activated with actinic radiation is employed per molecule, the groups are structurally different from one another or of identical structure.

Where they are structurally different from one another, this means for the purposes of the present invention that two, three, four or more, but especially two, groups activable with actinic radiation are used, deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, but especially acrylate groups.

The groups are preferably attached to the respective parent structures of the constituents (O) by way of urethane, urea, allophanate, ester, ether and/or amide groups, but especially by way of ester groups. Typically this occurs through customary and known polymer-analogous reactions such as, for instance, the reaction of pendent glycidyl groups with the above-described olefinically unsaturated monomers which comprise an acid group, of pendent hydroxyl groups with the halides of these monomers, of hydroxyl groups with isocyanates comprising double bonds, such as vinyl isocyanate, methacryloyl isocyanate and/or 1-(1-isocyanato-1-methylethyl)-3-(1-methylethenyl)benzene (TMI® from CYTEC) or of isocyanate groups with the above-described monomers containing hydroxyl groups.

Alternatively it is possible to employ mixtures of constituents (O) curable by means of heat alone and constituents (O) curable solely by means of actinic radiation.

Suitable constituents or binders (O) include
all of the binders that are described in the US patent U.S. Pat. No. 4,268,542 A1 or U.S. Pat. No. 5,379,947 A1 and in patent applications DE 27 10 421 A1, DE 195 40 977 A1, DE 195 18 392 A1, DE 196 17 086 A1, DE 196 13 547 A1, DE 19618 657 A1, DE 196 52 813 A1, DE 196 17 086 A1, DE 198 14 471 A1, DE 198 41 842 A1 or DE 198 41 408 A1, DE 199 08 018 or DE 199 08 013 or in European patent EP 0 652 264 A1 and are envisaged for use in powder clearcoat slurries curable thermally and/or with actinic radiation;
all of the binders described in patent applications DE 198 35 296 A1, DE 197 36 083 A1 or DE 198 41 842 A1 and envisaged for use in dual-cure clearcoat materials;
all of the binders described in German patent application DE 42 22 194 A1, the BASF Lacke+Farben AG product information material “Pulverlacke”, 1990, or the BASF Coatings AG company brochure “Pulverlacke, Pulverlacke für industrielle Anwendungen”, January, 2000, and intended for use in thermally curable powder clearcoat materials; or
all of the binders described in European patent applications EP 0 928 800 A1, 0 636 669 A1, 0 410 242 A1, 0 783 534 A1, 0 650 978 A1, 0 650 979 A1, 0 650 985 A1, 0 540 884 A1, 0 568 967 A1, 0 054 505 A1 or 0 002 866 A1, in German patent applications DE 197 09 467 A1, 42 03 278 A1, 33 16 593 A1, 38 36 370 A1, 24 36 186 A1 or 20 03 579 B1, in international patent applications WO 97/46549 or 99/14254, or in American patents U.S. Pat. Nos. 5,824,373 A, 4,675,234 A, 4,634,602 A, 4,424,252 A, 4,208,313 A, 4,163,810 A, 4,129,488 A, 4,064,161 A or 3,974,303 A and intended for use in UV-curable clearcoat and powder clearcoat materials.

The preparation of the constituents (O) has no methodological peculiarities but instead takes place by means of the customary and known methods of polymer chemistry, as described in detail in, for example, the patents recited above.

Further examples of suitable preparation processes for (meth)acrylate copolymers (O) are described in the European patent applications or EP 0 767 185 A1, in German patents DE 22 14 650 B1 or DE 27 49 576 B1, and in the American patents U.S. Pat. Nos. 4,091,048 A1, U.S. Pat. No. 3,781,379 A, U.S. Pat. No. 5,480,493 A, U.S. Pat. No. 5,475,073 A or U.S. Pat. No. 5,534,598 A, or in the standard text Houben-Weyl, Methoden der organischen Chemie, 4th edition, Volume 14/1, pages 24 to 255, 1961. Suitable reactors for the copolymerization include the customary and known stirred tanks, stirred-tank cascades, tube reactors, loop reactors or Taylor reactors, as described in, for example, the patents and patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins (O) is further described, for example, in the standard text Ullmanns Encyklopädie der technischen Chemie, 3rd edition, Volume 14, Urban & Schwarzenberg, Munich, Berlin, 1963, pages 80 to 89 and pages 99 to 105, and also in the following books: “Rèsines Alkydes-Polyesters” by J. Bourry, Paris, Verlag Dunod, 1952, “Alkyd Resins” by C. R. Martens, Reinhold Publishing Corporation, New York, 1961, and “Alkyd Resin Technology” by T. C. Patton Interscience Publishers, 1962.

The preparation of polyurethanes and/or acrylated polyurethanes (O) is additionally described for example in patent applications EP 0 708 788 A1, DE 44 01 544 A1 or DE 195 34 361 A1.

Examples of especially suitable constituents (O) are the (meth)acrylate copolymers containing epoxide groups, with an epoxide equivalent weight preferably of 400 to 2500, more preferably 420 to 2200, very preferably 430 to 2100, with very particular preference 440 to 2000 and in particular 440 to 1900, a number-average molecular weight (determined by gel permeation chromatography using a polystyrene standard) of preferably 2000 to 20 000 and in particular 3000 to 10 000, and a glass transition temperature (T_{g}) of preferably 30 to 80, more preferably 40 to 70, and in particular 40 to 60° C. (measured by means of differential scanning calometry (DSC), as described in patents and patent applications EP 0 299 420 A1, DE 22 14 650 B1, DE 27 49 576 B1, U.S. Pat. No. 4,091,048 A or U.S. Pat. No. 3,781,379 A.

Preferred suitable crosslinking agents (V) are polyisocyanates.

The polyisocyanates comprise on average at least 2.0, preferably more than 2.0, and in particular more than 3.0 isocyanate groups per molecule. There is in principle no upper limit on the number of isocyanate groups; in accordance with the invention, however, it is of advantage if the number does not exceed 15, preferably 12, more preferably 10, very preferably 8.0, and in particular 6.0.

Examples of suitable polyisocyanates are polyurethane prepolymers which contain isocyanate groups, can be prepared by reacting polyols with an excess of diisocyanates, and are of preferably low viscosity.

Examples of suitable diisocyanates are isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethyl-cyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane-2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimer fatty acids, as sold under the tradename DDI 1410 by Henkel and described in patents WO 97/49745 and WO 97/49747, especially 2-heptyl-3,4-bis(9-isocyanatononyl)-1-pentyl-cyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane or liquid bis(4-isocyanatocyclohexyl)methane with a trans/trans content of up to 30%, preferably 25%, and in particular 20% by weight, as is described in patent applications DE 44 14 032 A1, GB 1220717 A1, DE 16 18 795 A1 or DE 17 93 785 A1, preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop 1-yl)cyclohexane, 1-isocyanato-2-(3-isocyanatoeth-1-yl)cyclohexane, 1-isocyanato-2-(4-isocyanatobut-1-yl)cyclohexane or HDI, especially HDI.

It is also possible to use polyisocyanates which contain isocyanurate, biuret, allophanate, iminooxadiazinedione, urethane, urea, carbodiimide and/or uretdione groups and are prepared in conventional manner from the diisocyanates described above. Examples of suitable preparation processes and polyisocyanates are known from, for example, patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

Further examples of suitable crosslinking agents are blocked polyisocyanates.

Examples of suitable blocking agents for preparing the blocked polyisocyanates are the blocking agents known from the U.S. Pat. No. 4,444,954 A or U.S. Pat. No. 5,972,189 A, such as
i) phenols such as phenol, cresol, xylenol, nitrophenol, chlorophenol, ethylphenol, t-butylphenol, hydroxybenzoic acid, esters of this acid or 2,5-di-tert-butyl-4-hydroxytoluene;
ii) lactams, such as ε-caprolactam, δ-valerolactam, γ-butyrolactam or β-propiolactam;
iii) active methylenic compounds, such as diethyl malonate, dimethyl malonate, methyl or ethyl acetoacetate or acetylacetone;
iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, methoxymethanol, 2-(-hydroxyethoxy)phenol, 2-(hydroxypropoxy)phenol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;
vi) acid amides such as acetoanilide, acetoanisidinamide, acrylamide, methacrylamide, acetamide, stearamide or benzamide;
vii) imides such as succinimide, phthalimide or maleimide;
viii) amines such as diphenylamine, phenylnaphthylamine, xylidine, N-phenylxylidine, carbazole, aniline, naphthylamine, butylamine, dibutylamine or butylphenylamine;
ix) imidazoles such as imidazole or 2-ethylimidazole;
x) ureas such as urea, thiourea, ethyleneurea, ethylenethiourea or 1,3-diphenylurea;
xi) carbamates such as phenyl N-phenylcarbamate or 2-oxazolidone;
xii) imines such as ethylenimine;
xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;
xiv) salts of sulfurous acid such as sodium bisulfite or potassium bisulfite;
xv) hydroxamic esters such as benzyl methacrylohydroxamate (BMH) or allyl methacrylohydroxamate; or
xvi) substituted pyrazoles, ketoximes, imidazoles or triazoles; and also
   mixtures of these blocking agents, especially dimethylpyrazole and triazoles, malonic esters and acetoacetic esters, dimethylpyrazole and succinimide or butyl diglycol and trimethylolpropane.

As polyvalent isocyanates it is preferred to use mixtures of aliphatic polyisocyanates having an average functionality of 3 to 6, preferably 3.5 to 5, isocyanate groups per mole. The amount of isocyanate is preferably chosen such that 1.2 to 3, especially 1.5 to 2.5, isocyanate groups react per hydroxyl group of the (co)polymer; the remaining isocyanate groups are converted into urea groups by reaction with amines.

Examples that may be mentioned of particularly suitable isocyanate mixtures are mixtures of 0.1% to 10%, especially 0.3% to 8%, by weight of a diisocyanate (e.g., hexamethylene diisocyanate), 30% to 80%, especially 42% to 79%, by weight of a triisocyanate (e.g., trifunctional biuret of hexamethylene diisocyanate), and 20% to 60%, especially 22% to 50%, by weight of an isocyanate having a functionality of 4 to 10 (e.g., a corresponding higher polyfunctional biuret of hexamethylene diisocyanate).

Further examples of suitable crosslinking agents are all known aliphatic and/or cycloaliphatic and/or aromatic, low molecular weight, oligomeric and polymeric polyepoxides, based for example on bisphenol A or bisphenol F. Examples of suitable polyepoxides include the polyepoxides available commercially under the names Epikote® from Shell, Denacol® from Nagase Chemicals Ltd., Japan, such as Denacol EX-411 (pentaerythritol polyglycidyl ether), Denacol EX-321 (trimethylolpropane polyglycidyl ether), Denacol EX-512 (polyglycerol polyglycidyl ether), and Denacol EX-521 (polyglycerol polyglycidyl ether), or the glycidyl ester of trimellitic acid or triglycidyl isocyanurate (TGIC).

As crosslinking agents it is additionally possible to use tris(alkoxycarbonylamino)triazines (TACT) in which the alkyl radicals comprise 1 to 10 carbon atoms.

Examples of suitable tris(alkoxycarbonylamino)triazines are described in patents U.S. Pat. No. 4,939,213 A, U.S. Pat. No. 5,084,541 A or EP 0 624 577 A1. In particular the tris(methoxy-, tris(n-butoxy- and/or tris(2-ethylhexyloxycarbonylamino)triazines are used.

Of advantage are the methyl butyl mixed esters, the butyl 2-ethylhexyl mixed esters, and the butyl esters. These have the advantage over the straight methyl ester of better solubility in polymer melts and also have less of a tendency to crystallize out.

In addition it is possible to use amino resins, melamine resins for example, as crosslinking agents. In this context it is possible to use any amino resin that is suitable for transparent topcoat or clearcoat materials, or a mixture of such amino resins. Particularly suitable are the customary and known amino resins some of whose methylol and/or methoxymethyl groups have been defunctionalized by means of carbamate or allophanate groups. Crosslinking agents of this kind are described in patents U.S. Pat. No. 4,710,542 A and EP 0 245 700 B1 and also in the article by B. Singh and coworkers, “Carbamylmethylated Melamines, Novel Crosslinkers for the Coatings Industry” in Advanced Organic Coatings Science and Technology Series, 1991, Volume 13, pages 193 to 207. The amino resins can also be employed as binders (O).

Further examples of suitable crosslinking agents are beta-hydroxyalkylamides such as N,N,N′,N′-tetrakis(2-hydroxyethyl)adipamide or N,N,N′,N′-tetrakis(2-hydroxypropyl)-adipamide.

In addition it is possible to use carboxylic acids, especially saturated, straight-chain, aliphatic dicarboxylic acids having 3 to 20 carbon atoms in the molecule, particularly dodecanedioic acid.

Further examples of suitable crosslinking agents are siloxanes, especially siloxanes having at least one trialkoxy- or dialkoxy-silane group.

The specific crosslinking agents employed depend on the complementary reactive functional groups present in the binders of the aqueous basecoat materials.

The present invention further provides for the use of the curable aqueous basecoat materials for automotive OEM finishing, the painting of built structures, both interiors and exteriors, the painting of doors, windows, and furniture, industrial coating, including coil coating, container coating, and the impregnation and/or coating of electrical components, and also the coating of white goods, including household appliances, boilers, and radiators.

Particular preference is given to use in automotive OEM finishing or automotive refinish, especially in automotive OEM finishing.

The curable aqueous basecoat materials are referred to in this text for the sake of brevity “aqueous basecoat materials”.

The aqueous basecoat materials are curable precursors of thermoplastic or thermosetting polymers which are applied in liquid, solution and/or preferably dispersion form to preferably metallic substrates. This is typically done using coating units as are known per se to the skilled worker. In this context the two fundamental advantages of aqueous basecoat materials become apparent: the complete or substantial absence of organic solvents, and the ease of recycling the overspray into the coating process.

Besides the polycarbonates, the curable aqueous basecoat materials optionally comprise at least one functional constituent (F) of an aqueous basecoat material. The aqueous basecoat material further comprises at least one oligomeric and/or polymeric constituent (O) as binder, and at least one crosslinker (V).

Suitable functional constituents (F) include all constituents typical of coating materials, with the exception of the substances specified under (O) or (V), and also the hyperbranched polycarbonates.

The aqueous basecoat materials of the invention may comprise the functional constituent (F) in typical coating amounts, at for example between 0.1% and 5% by weight, based on its solids.

Examples of suitable, typical coating constituents (F) are organic and inorganic, transparent or opaque fillers and/or nanoparticles and/or auxiliaries and/or additives such as UV absorbers, light stabilizers, free-radical scavengers, devolatilizers, slip additives, polymerization inhibitors, crosslinking catalysts, thermolabile free-radical initiators, photoinitiators, thermally curable reactive diluents, reactive diluents curable with actinic radiation, adhesion promoters, flow control agents, film-forming assistants, flame retardants, corrosion inhibitors, free-flow aids, waxes and/or matting agents. The constituents (F) can be employed individually or as mixtures.

For the purposes of the present invention actinic radiation means electromagnetic radiation such as near infrared, visible light, UV radiation or X-radiation, especially UV radiation, or particulate radiation such as electron beams.

Examples of suitable organic and inorganic fillers are chalk, calcium sulfates, barium sulfate, silicates such as talc, mica or kaolin, silicas, oxides such as aluminum hydroxide or magnesium hydroxide, or organic fillers such as plastics powders, especially those of polyamide or polyacrylonitrile. For further details refer to Römpp Lexikon Lacke und Druckfarben, Georg Thieme Verlag, 1998, pages 250 ff., “Fillers”.

Preference is given to employing mica and talc if an aim is to improve the scratch resistance of the coatings produced from the aqueous basecoat materials.

In addition it is of advantage to use mixtures of platelet-shaped inorganic fillers such as talc or mica and nonplatelet-shaped inorganic fillers such as chalk, dolomite, calcium sulfates or barium sulfate, since this allows the viscosity and rheology to be adjusted very effectively.

Examples of suitable transparent fillers are those based on silicon dioxide, aluminum oxide or zirconium oxide, but especially nanoparticles on this basis.

Further suitable constituents (F) include auxiliaries and/or additives such as UV absorbers, light stabilizers, free-radical scavengers, devolatilizers, slip additives, polymerization inhibitors, crosslinking catalysts, thermolabile free-radical initiators, photoinitiators, thermally curable reactive diluents, reactive diluents curable with actinic radiation, adhesion promoters, flow control agents, film-forming assistants, flame retardants, corrosion inhibitors, free-flow aids, waxes and/or matting agents, which can be employed individually or as mixtures.

Examples of suitable thermally curable reactive diluents are positionally isomeric diethyloctanediols or hydroxyl-comprising hyperbranched compounds or dendrimers, as described in patent applications DE 198 09 643 A1, DE 198 40 605 A1 or DE 198 05 421 A1.

Examples of suitable reactive diluents curable with actinic radiation are those described in Römpp Lexikon Lacke und Druckfarben, Georg Thieme Verlag, Stuttgart, New York, 1998, on page 491 in the entry headed “Reactive diluents”.

Examples of suitable thermolabile free-radical initiators are organic peroxides, organic azo compounds or C—C-cleaving initiators such as dialkyl peroxides, peroxocarboxylic acids, peroxodicarbonates, peroxide esters, hydroperoxides, ketone peroxides, azo dinitriles or benzpinacol silyl ethers.

Examples of suitable crosslinking catalysts are bismuth lactate, citrate, ethylhexanoate or dimethylolpropionate, dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole, and 2-butylimidazole, as described in Belgian Patent No. 756,693, or phosphonium catalysts such as ethyltriphenylphosphonium iodide, ethyltriphenylphos-phonium chloride, ethyltriphenylphosphonium thiocyanate, ethyltriphenylphosphonium acetate-acetic acid complex, tetrabutylphosphonium iodide, tetrabutylphosphonium bromide, and tetrabutylphosphonium acetate-acetic acid complex, as described in for example the US patents U.S. Pat. No. 3,477,990 A or U.S. Pat. No. 3,341,580 A.

Examples of suitable photoinitiators are described in Römpp Chemie Lexikon, 9th, expanded and revised edition, Georg Thieme Verlag Stuttgart, Vol. 4, 1991, or in Römpp Lexikon Lacke und Druckfarben, Georg Thieme Verlag Stuttgart, 1998, pages 444 to 446.

Examples of suitable antioxidants are hydrazines and phosphorus compounds.

Examples of suitable light stabilizers are HALS compounds, benzotriazoles or oxalanilides.

Examples of suitable free-radical scavengers and polymerization inhibitors are organic phosphites or 2,6-di-tert-butylphenol derivatives.

Examples of suitable devolatilizers are diazadicycloundecane or benzoin.

Further examples of the functional constituents (F) recited above, and also of further functional constituents (F), are described in detail in the textbook “Lackadditive” [Additives for Coatings] by Johan Bieleman, Wiley-VCH, Weinheim, N.Y., 1998.

Examples of such further additives are antifoams, wetting agents, adhesion promoters, catalysts, flow control agents, anticrater agents, light stabilizers, and thickeners such as, for example, synthetic polymers having ionic and/or associative groups such as polyvinyl alcohol, poly(meth)acrylamide, poly(meth)acrylic acid, polyvinylpyrrolidone, hydrophobically modified ethoxylated polyurethanes or polyacrylates, crosslinked or noncrosslinked polymer microparticles.

The aqueous basecoat materials of the invention may further comprise at least one pigment (G), examples being color and/or effect pigments, fluorescent pigments, electrically conductive pigments and/or magnetically shielding pigments, metal powders or soluble organic dyes.

Examples of coloring inorganic or organic pigments and extenders are titanium dioxide, micronized titanium dioxide, iron oxide pigments, carbon black, silicon dioxide, barium sulfate, micronized mica, talc, kaolin, chalk, phyllosilicates, azo pigments, phthalocyanine pigments, quinacridone pigments, pyrrolopyrrole pigments, and perylene pigments.

Examples of effect pigments are metal pigments, of aluminum, copper or other metals, for example; interference pigments such as, for example, metal oxide-coated metal pigments, examples being titanium dioxide-coated aluminum, coated micas such as titanium dioxide-coated mica, graphite effect pigments, platelet-shaped iron oxide, platelet-shaped copper phthalocyanine pigments. The effect pigments are generally introduced in the form of a commercially customary aqueous or nonaqueous paste, admixed if appropriate with preferably water-dilutable organic solvents and additives, and thereafter mixed with aqueous binder, with shearing. Effect pigments in powder form can be first processed to a paste with preferably water-dilutable organic solvents and additives.

Examples of suitable effect pigments are metal flake pigments such as commercially customary aluminum bronzes, aluminum bronzes chromated in accordance with DE 36 36 183 A1, and commercially customary stainless steel bronzes, and also nonmetallic effect pigments, such as pearlescent pigments and interference pigments, platelet-shaped effect pigments based on iron oxide having a shade from pink to brownish red, or liquid-crystalline effect pigments, for example. For further details refer to Römpp Lexikon Lacke und Druckfarben, Georg Thieme Verlag, 1998, pages 176, “Effect pigments” and pages 380 and 381 “metal oxide-mica pigments” to “metal pigments”, and to the patent applications and patents DE 36 36 156 A1, DE 37 18 446 A1, DE 37 19 804 A1, DE-39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A.

Examples of suitable inorganic color pigments are white pigments such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details refer to Römpp Lexikon Lacke und Druckfarben, Georg Thieme Verlag, 1998, pages 180 and 181, “Iron blue pigments” to “Black iron oxide”, pages 451 to 453 “Pigments” to “Pigment volume concentration”, page 563 “Thioindigo pigments”, page 567 “Titanium dioxide pigments”, pages 400 and 467, “Naturally occurring pigments”, page 459 “Polycyclic pigments”, page 52, “Azomethine pigments”, “Azo pigments”, and page 379, “Metal complex pigments”.

Examples of fluorescent pigments (daylight-fluorescent pigments) are bis(azomethine) pigments.

Examples of suitable electrically conductive pigments are titanium dioxide/tin oxide pigments.

Examples of magnetically shielding pigments are pigments based on iron oxides or chromium dioxide.

Examples of suitable metal powders are powders of metals and metal alloys of aluminum, zinc, copper, bronze or brass.

Suitable soluble organic dyes are lightfast organic dyes having little or no tendency to migrate from the aqueous basecoat material and from the coatings produced from it. The migration tendency can be estimated by the skilled worker on the basis of his or her general art knowledge and/or determined by means of simple preliminary rangefinding tests, as part of tinting tests, for example.

The weight ratio of pigment (G) or functional constituent (F) (if present) to binder in the aqueous basecoat material is for example between 0.05:1 to 3:1; for effect aqueous basecoat materials it is for example preferably 0.1:1 to 0.6:1; for solid-color aqueous basecoat materials it is preferably higher, for example, at 0.1:1 to 2.5:1, based in each case on the weight of solids.

Color pigments and/or fillers may be ground, for example, in a portion of the aqueous binder. Grinding, may also take place with preference in a special water-dilutable paste resin. Grinding may take place in typical assemblies known to the skilled worker. Thereafter the rest of the aqueous binder or aqueous paste resin is used to make up the completed color pigment dispersion.

The incorporation of the high-functionality, highly branched or hyperbranched polycarbonates may take place at any stage in the preparation of the aqueous basecoat materials, including, for example, only as an additive to the otherwise completed aqueous basecoat material, in the form, for example, of a retrospectively added correction agent. Stable incorporation of the high-functionality, highly branched or hyperbranched polycarbonates is generally accomplished without particular cost or complexity in the mixing operation. If appropriate, dispersing may be necessary.

The aqueous basecoat materials of the invention are especially suitable for coating substrates such as plastics surfaces, glass, ceramic, leather, mineral building materials, such as cement moldings and fiber cement slabs, and especially for wood and MDF, and more particularly for metals, including coated metals.

Examples of suitable substrates for the aqueous basecoat materials of the invention are thermoplastic polymers, more particularly polymethyl methacrylates, polybutyl methacrylates, polyethylene terephthalates, polybutylene terephthalates, polyvinylidene fluorides, polyvinyl chlorides, polyesters, polyolefins, acryinitrile-ethylene-propylene-diene-styrene copolymers (A-EPDM), polyetherimides, polyetherketones, polyphenylene sulfides, polyphenylene ethers or blends thereof.

Mention may be made additionally of polyethylene, polypropylene, polystyrene, polybutadiene, polyesters, polyamides, polyethers, polycarbonate, polyvinyl acetal, polyacrylonitrile, polyacetal, polyvinyl alcohol, polyvinyl acetate, phenolic resins, urea resins, melamine resins, alkyd resins, epoxy resins or polyurethanes, block copolymers or graft copolymers thereof, and blends of these.

Mention may be made with preference of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF, UP plastics (abbreviations according to DIN 7728), and aliphatic polyketones.

Particularly preferred substrates are polyolefins, such as PP (polypropylene), which optionally may be isotactic, syndiotactic or atactic and optionally may be unoriented or have been oriented by uniaxial or biaxial stretching, SAN (styrene-acrylonitrile copolymers), PC (polycarbonates), PVC (polyvinyl chlorides), PMMA (polymethyl methacrylates), PBT (poly(butylene terephthalate)s), PA (polyamides), ASA (acrylonitrile-styrene-acrylic ester copolymers), and ABS (acrylonitrile-butadiene-styrene copolymers), and also their physical mixtures (blends). Particular preference is given to PP, SAN, ABS, ASA and also blends of ABS or ASA with PA or PBT or PC. Very particular preference is given to polyolefins, PMMA and PVC.

Especially preferred is ASA, more particularly in accordance with DE 196 51 350, and the blend ASA/PC. Preference is likewise given to polymethyl methacrylate (PMMA) or to impact-modified PMMA.

A further-preferred substrate for coating with the aqueous basecoat materials of the invention are metals, which if appropriate may have been pretreated with a primer.

The metal in question may in principle be of any type. More particularly, however, the metals or alloys in question are those which are typically used as metallic materials of construction and which require protection from corrosion.

The surfaces in question are more particularly those of iron, steel, Zn, Zn alloys, Al or Al alloys. These may be the surfaces of articles composed wholly of said metals and/or alloys. Alternatively the bodies may only have been coated with these metals and may themselves consist of other kinds of materials, such as of other metals, alloys, polymers or composites, for example. The surfaces in question may be those of castings, of galvanized iron or of steel. In one preferred embodiment of the present invention the surfaces in question are of steel.

Zn or Al alloys are known to the skilled worker. Depending on the desired end use, the skilled worker selects the nature and amount of alloying components. Typical components of zinc alloys include more particularly Al, Pb, Si, Mg, Sn, Cu or Cd. Typical components of aluminum alloys include, in particular, Mg, Mn, Si, Zn, Cr, Zr, Cu or Ti. The Al/Zn alloys in question may be alloys in which Al and Zn are present in approximately equal amounts. Steel coated with alloys of this kind is available commercially. The steel may comprise the typical alloying components known to the skilled worker.

Also conceivable is the use of the aqueous basecoat materials of the invention to treat tin-plated iron/steel (tinplate).

The aqueous basecoat materials of the invention are additionally suitable for coating substrates such as wood, paper, textile, leather, nonwoven, plastics surfaces, glass, ceramic, mineral building materials, such as cement moldings and fiber cement slabs, or metals, including coated metals, preferably of plastics or metals, more particularly in the form of films or foils, and more preferably metals.

More particularly the aqueous basecoat materials are used for producing coatings on pipes (pipelines), wire goods of all kinds, flanges and fittings in the interior and exterior segments, wall-mounted wardrobes and bedframes, fence posts, garden furniture, traffic barriers, laboratory equipment, wire gratings, inserts for dishwashers, shopping baskets, machinery components, electrical machinery, rotors, stators, electrical coils, insulation boxes, boilers, brake cylinders, chemical plant or roadsigns.

For coating, the typical approach is to carry out conventional coating with the aqueous basecoat materials of the invention, then to carry out drying and curing to remove any solvent present.

The coating of the substrates takes place in accordance with typical methods that are known to the skilled worker, in which at least one aqueous basecoat material is applied in the desired thickness to the target substrate and the volatile constituents are removed. This operation may if desired be repeated one or more times. Application to the substrate may take place in a known way, as for example by injecting, spraying, knife coating, brushing, rolling, roller coating, and in particular by electrostatic spraying or compressed-air spraying. The coating thickness is generally in a range from about 3 to 1000 g/m² and preferably 10 to 200 g/m².

The inventively modified color and/or effect aqueous basecoat materials may find use in the production of multicoat finishes, more particularly decorative basecoat/clear two-coat finishes, and generally in multicoat finishes.

The aqueous basecoat materials of the invention are suitable for producing multicoat finishes, more particularly color and/or effect multicoat finishes, preferably two-coat finishes in the motor vehicle segment. They are suitable for automotive OEM finishing and automotive refinish, but can also be employed in other areas, such as the painting of plastics, more particularly the painting of automotive parts.

The invention accordingly also provides a process for producing multicoat finishes, preferably two-coat finishes, by application of an inventive aqueous basecoat material and a clearcoat material. The aqueous basecoat materials of the invention can be applied to a wide variety of different kinds of substrate. In general the substrates in question are metallic or plastic. In many cases they have been coated beforehand—i.e., plastic substrates may have been provided, for example, with a plastics primer; metallic substrates generally possess a priming coat, applied by electrophoresis, for example, and may further carry one or more additional paint coats, such as a surfacer coat, for example. The aqueous basecoat materials of the invention are applied preferably by spraying in a dry film thickness of 8 to 50 μm; for effect aqueous basecoat materials the dry film thickness is, for example, preferably 10 to 25 μm, while for solid-color aqueous basecoat materials is preferably higher, at for example 10 to 40 μm.

Application takes place preferably by the wet-on-wet method; i.e., after a flash-off phase, at 20 to 60° C., for example, the aqueous basecoat films are overcoated with a conventional clearcoat material in a dry film thickness of preferably 30 to 60 μm, and are dried or crosslinked together with the clearcoat film at temperatures of, for example, 20 to 150° C. The conditions under which the multicoat finish comprising aqueous basecoat and clearcoat is dried are governed by the clearcoat system used. For refinish purposes, for example, temperatures of 20 to 80° C. are preferred. For OEM finishing purposes, temperatures above 100° C. are preferred, above 110° C., for example.

The formation of a veil-like, milky coating that is sometimes observed in the prior art on the surface of the clearcoat cannot be observed, even in the case of dark shades, in multicoat finishes produced using the aqueous basecoat materials of the invention.

Suitability as clearcoat material is possessed in principle by all known clearcoat materials or transparently pigmented coating compositions. In this context it is possible to use solventborne one-component (1K) or two-component (2K) clearcoat materials, water-dilutable 1K or 2K clearcoat materials, powder clearcoat materials or aqueous powder clearcoat slurries. It is preferred to use 2K polyurethane clearcoat materials for overcoating basecoat films produced from aqueous basecoat materials of the invention. Through the inventive use of the high-functionality, highly branched or hyperbranched polycarbonates in conventional color and/or effect aqueous basecoat materials it is possible in particular to achieve a marked reduction in the wetting limit.

The present invention will be illustrated with reference to the examples below.

Hyperbranched Polycarbonates:

### General Operating Procedure:

Polyfunctional polyols used were ethoxylates or propoxylates based on trimethylolpropane (TMP) or glycerol (Glyc) as a starter molecule, their compositions fluctuating on a statistical average around the values specified in Table 1 for the degree of grafting with ethylene oxide (EO) or propylene oxide (PO).

The polyfunctional polyol, diethyl carbonate, and potassium carbonate or potassium hydroxide as catalyst (amount based on amount of polyol in ppm by weight) were charged in accordance with the batching amounts of Table 1 to a three-neck flask equipped with stirrer, reflux condenser, and internal thermometer, and the mixture is heated to 140° C. and stirred at this temperature for 2 h. As reaction time progressed, there was a reduction in the temperature of the reaction mixture, owing to the onset of evaporative cooling by the ethanol released. Then the reflux condenser was switched for a descending condenser; one equivalent of phosphoric acid was added, based on the equivalent amount of catalyst; ethanol was distilled off; and the temperature of the reaction mixture was slowly raised to 160° C. The alcohol removed by distillation was collected in a chilled, round-bottomed flask and weighed, and the conversion was determined in this way as a percentage of the theoretically possible complete conversion (see Table 1).

Subsequently, dry nitrogen was passed through the reaction mixture at 160° C. for a period of 1 h in order to remove any residual amounts of monomers still present. Thereafter the reaction mixture was cooled to room temperature.

The polycarbonates were analyzed by gel permeation chromatography, using a refractometer as the detector. The mobile phase used was dimethylacetamide; the standard used for determining the molecular weight was polymethyl methacrylate (PMMA).

TABLE 1
Polycarbonates, starting materials and end products

| | | | | Distillate, | Molec- |
|---|---|---|---|---|---|
| | | | | amount of | ular |
| | | Molar | | ethanol | weights |
| | | ratio of | | based on | GPC |
| | | polyol to | Catalyst, ppm by | complete | (g/mol) |
| | | diethyl | weight, based on | conversion | Mw |
| Ex. | Polyol | carbonate | amount of polyol | mol % | Mn |
| 1 | TMP × 3 EO | 1:1 | K₂CO₃ | 66 | 2000 |
| | | | 150 | | 1170 |
| 2 | TMP × 3 EO | 1:1 | K₂CO₃ | 95 | 10300 |
| | | | 150 | | 2300 |
| 3 | TMP × 3 EO | 1:1.1 | K₂CO₃ | 93 | 23600 |
| | | | 150 | | 2700 |
| 4 | TMP × 12 EO | 1:1 | KOH | 90 | 25600 |
| | | | 200 | | 3900 |
| 5 | TMP × 12 EO | 1:1 | KOH | 80 | 6800 |
| | | | 150 | | 2700 |
| 6 | TMP × 5.4 PO | 1:1 | KOH | 85 | 4000 |
| | | | 200 | | 1700 |
| 7 | TMP × 5.4 PO | 1:1.3 | KOH | 81 | 23300 |
| | | | 100 | | 2700 |
| 8 | TMP × 1.2 PO | 1:1 | K₂CO₃ | 70 | 1400 |
| | | | 150 | | 850 |
| 9 | Glyc × 5 EO | 1:1 | K₂CO₃ | 93 | 8800 |
| | | | 150 | | 2400 |

### APPLICATION EXAMPLES

Use of the polycarbonates of the invention in aqueous basecoat material:

### Example 10

The commercial product Black Magic® was subjected to a test to determine the wetting limit of the clearcoat (CC) on the basecoat as a function of the clearcoat film thickness. A blend of this commercial product with 0.5% of the polycarbonate (PC) from Example 5 (Table 1) was likewise subjected to this testing.

The results obtained were as follows:

| | |
|---|---|
| Wetting limit for Black Magic ®: | 21 μm CC film thickness |
| Wetting limit for Black Magic ® + 0.5% PC | 13 μm CC film thickness |

### Example 11

The commercial product Sunset Red® was subjected to a test to determine the wetting limit of the clearcoat on the basecoat as a function of the clearcoat film thickness.

A blend of this commercial product with 0.5% of the polycarbonate (PC) from Example 5 (Table 1) was likewise subjected to this testing.

The results obtained were as follows:

| | |
|---|---|
| Wetting limit for Sunset Red ®: | 17 μm CC film thickness |
| Wetting limit for Sunset Red ® + 0.5% PC: | 14 μm CC film thickness |

1. An aqueous basecoat material comprising at least one high-functionality, highly branched or hyperbranched, uncrosslinked polycarbonate.

2. The aqueous basecoat material according to claim 1, wherein the fraction of the polycarbonate is 0.1% to 15% by weight.

3. The aqueous basecoat material according claim 1, comprising one or more binders.

4. The aqueous basecoat material according to claim 1, wherein the polycarbonate is obtained by a process comprising:
a) preparing one or more condensation products (K) by either
a1) reacting at least one organic carbonate (A) of general formula RO[(CO)O]ₙR with at least one aliphatic, aliphatic/aromatic or aromatic alcohol (B1) containing at least 3 OH groups, with elimination of alcohols ROH, R, independently at each occurrence, being a straight-chain or branched aliphatic, aromatic/aliphatic or aromatic hydrocarbon radical having 1 to 20 carbon atoms, and it also being possible for the radicals R to be joined to one another to form a ring, and n being an integer from 1 to 5
or
a2) reacting phosgene, diphosgene or triphosgene with said aliphatic, aliphatic/aromatic or aromatic alcohol (B1), with release of hydrogen chloride, and
b) intermolecularly reacting the condensation products (K) to give a high-functionality, highly branched or hyperbranched polycarbonate,
the proportion of the OH groups to the phosgenes or the carbonates in the reaction mixture being chosen such that the condensation products (K) contain on average either one carbonate or carbamoyl chloride group and more than one OH group, or one OH group and more than one carbonate or carbamoyl chloride group.

5. The aqueous basecoat material according to claim 4, wherein the alcohol (B1) is reacted with one to 30 molecules of ethylene oxide and/or propylene oxide and/or isobutylene oxide per hydroxyl group.

6. The aqueous basecoat material according to claim 4, wherein the alcohol (B1) is at least one selected from the group consisting of glycerol, trimethylolethane, trimethylolpropane, 1,2,4-butanetriol and pentaerythritol.

7. The aqueous basecoat material according to claim 1, wherein the polycarbonate is at least partly reacted with at least one monofunctional polyalkylene oxide polyether alcohol.

8. The aqueous basecoat material according to claim 1, having a solids content of 10% to 50% by weight.

9-10. (canceled)

11. An automotive OEM finishing, an automotive refinish, an interior painting, an exterior painter, a painting of doors, windows, and furniture, an industrial coating, a coil coating, a container coating, an electrical component, a coating of white goods, including a household appliance, a boiler, a radiator, a pipe, a wire good, a flange, a fitting, a wall-mounted wardrobe, a bedframe, a fence post, a garden furniture, a traffic barrier, a laboratory equipment, a wire grating, an insert for dishwashers, a shopping basket, a machinery component, an electrical machinery, a rotor, a stator, an electrical coil, an insulation box, a boiler, a brake cylinder, a chemical plant or a roadsign comprising the aqueous basecoat material according to claim 1.

12. A process for making a coated substrate comprising applying the aqueous basecoat material according to claim 1 to at least one substrate selected from the group consisting of plastic, glass, ceramic, leather, mineral building material, cement molding, fiber cement slab, wood, MDF, metal, and coated metal.

13. The aqueous basecoat material according to claim 3, further comprising at least one pigment.

14. The aqueous basecoat material according to claim 3, further comprising at least one filler, at least one crosslinker, at least one organic solvent, or at least one coating additive.

15. The aqueous basecoat material according to claim 4, wherein said ring comprises a five- to six-membered ring.

16. The aqueous basecoat material according to claim 5, wherein the alcohol (B1) is at least one selected from the group consisting of glycerol, trimethylolethane, trimethylolpropane, 1,2,4-butanetriol and pentaerythritol.
